(19) United States
(12) Patent Application Publication
(10) Pub. No.: US 2012/0166377 A1
(43) Pub. Date: Jun. 28, 2012

(54) METHOD AND APPARATUS FOR PROVIDING RECOMMENDATIONS BASED ON A RECOMMENDATION MODEL AND A CONTEXT-BASED RULE

(75) Inventors: Sailesh Kumar Sathish, Tampere (FI); Jari Pekka Hämäläinen, Kangasala As (FI)

(73) Assignee: Nokia Corporation, Espoo (FI)

(21) Appl. No.: 12/979,016

(22) Filed: Dec. 27, 2010

(51) Int. Cl. G06N 5/02

(52) U.S. Cl. 706/47

(57) ABSTRACT

An approach is provided for providing recommendations based on a recommendation model and a context-based rule. A recommendation platform receives a request for generating at least one recommendation, the request including at least one user identifier, at least one application identifier, or a combination thereof. Next, the recommendation platform determines at least one recommendation model associated with the at least one user identifier, the at least one application identifier, or a combination thereof. Then, the recommendation platform determines at least one context-based recommendation rule. Then, the recommendation platform processes and/or facilitates a processing of the at least one recommendation model, the at least one context-based recommendation rule, or a combination thereof for generating the at least one recommendation.

### BACKGROUND

Service providers and device manufacturers (e.g., wireless, cellular, etc.) are continually challenged to deliver value and convenience to consumers by, for example, providing compelling network services. One area of development has been the use of recommendation systems to provide users with suggestions or recommendations for content, items, etc. available within the services and/or related applications (e.g., recommendations regarding people, places, or things of interest such as companions, restaurants, stores, vacations, movies, video on demand, books, songs, software, articles, news, images, etc.). For example, a typical recommendation system may suggest an item to a user based on a prediction that the user would be interested in the item—even if that user has never considered the item before—by comparing the user's preferences to one or more reference characteristics. Such recommendation systems historically have been based on collaborative filters that rely on often large amounts of user data (e.g., historical rating information, use history, etc.). However, such user data often is not available or has not been collected with respect to a particular service or application, especially if the service or the application is new. Further, the conventional models lack flexibility in terms of customizing or developing variations of the models. For example, it is difficult to make changes to the models after the models are built based on the large amount of user data. Accordingly, service providers and device manufacturers face significant technical challenges to enabling development and generation of recommendation systems and models that can provide flexibility in their uses.

### SOME EXAMPLE EMBODIMENTS

Therefore, there is a need for an approach for providing recommendations based on a recommendation model and a context-based rule.

According to one embodiment, a method comprises receiving a request for generating at least one recommendation, the request including at least one user identifier, at least one application identifier, or a combination thereof. The method also comprises determining at least one recommendation model associated with the at least one user identifier, the at least one application identifier, or a combination thereof. The method further comprises determining at least one context-based recommendation rule. The method further comprises causing, at least in part, processing of the at least one recommendation model, the at least one context-based recommendation rule, or a combination thereof for generating the at least one recommendation.

According to another embodiment, an apparatus comprises at least one processor, and at least one memory including computer program code, the at least one memory and the computer program code configured to, with the at least one processor, cause, at least in part, the apparatus to receive a request for generating at least one recommendation, the request including at least one user identifier, at least one application identifier, or a combination thereof. The apparatus is also caused to determine at least one recommendation model associated with the at least one user identifier, the at least one application identifier, or a combination thereof. The apparatus is further caused to determine at least one context-based recommendation rule. The apparatus is further caused to

According to another embodiment, a computer-readable storage medium carries one or more sequences of one or more instructions which, when executed by one or more processors, cause, at least in part, an apparatus to receive a request for generating at least one recommendation, the request including at least one user identifier, at least one application identifier, or a combination thereof. The apparatus is also caused to determine at least one recommendation model associated with the at least one user identifier, the at least one application identifier, or a combination thereof. The apparatus is further caused to determine at least one context-based recommendation rule. The apparatus is further caused to cause, at least in part, processing of the at least one recommendation model, the at least one context-based recommendation rule, or a combination thereof for generating the at least one recommendation.

According to another embodiment, an apparatus comprises means for receiving a request for generating at least one recommendation, the request including at least one user identifier, at least one application identifier, or a combination thereof. The apparatus also comprises means for determining at least one recommendation model associated with the at least one user identifier, the at least one application identifier, or a combination thereof. The apparatus further comprises means for determining at least one context-based recommendation rule. The apparatus further comprises means for causing, at least in part, processing of the at least one recommendation model, the at least one context-based recommendation rule, or a combination thereof for generating the at least one recommendation.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-49.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing recommendations based on a recommendation model and a context-based rule, according to one embodiment;

FIGS. 2A and 2B are diagrams of the components of a server end and a client end, according to one embodiment;

FIG. 3A-3C are flowcharts of processes for providing recommendations based on a recommendation model and a context-based rule, according to one embodiment, according to one embodiment;

FIGS. 4A and 4B are diagrams of user interfaces utilized in the processes of FIG. 3, according to one embodiment;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for providing recommendations based on a recommendation model and a context-based rule are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

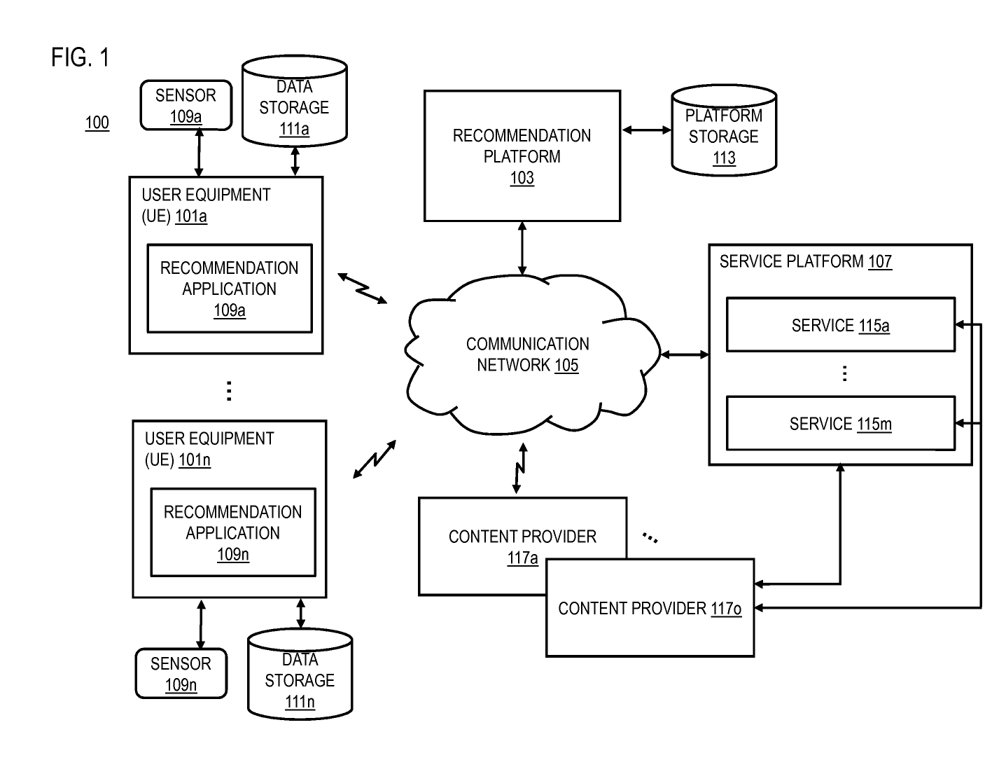

FIG. 1 is a diagram of a system capable of providing recommendations based on a recommendation model and a context-based rule, according to one embodiment. As previously discussed, recommendation systems provide users with a number of advantages over traditional methods of search in that recommendation systems not only circumvent the time and effort of searching for items of interest, but they may also help users discover items that the users may not have found themselves. However, recommendation systems can be very complex due to the number of variables, functions, and data that are used to create models (e.g., collaborative filtering) for generating recommendations. By way of example, a recommendation system for a particular application may take into consideration variables such as items viewed, item viewing times, items searched, items downloaded/uploaded, items purchased, items added to a wish list, shopping cart, or favorites list, items rated and how they were rated, etc. A recommendation system may also include complex algorithms to generate a recommendation based on these variables. Nevertheless, even when the numerous variables and functions have been satisfied, a recommendation system generally still requires sufficient data (e.g., item data, user data, etc.) to effectively seed its models to produce user suggestions. Thus, the conventional approach of collaborative-based recommendations only is not suitable for making recommendations for new information that does not yet exist in the model. Further, because the conventional approach with models is derived based on the usage interaction with their respective applications, and thus are very application-specific and a generic recommendation that is not specific to an application may be difficult to generate. In addition, the conventional approach does not consider the context information in depth, wherein the context information is to be well-reflected in the generic recommendation approach. For these various reasons, personalizing the models is difficult to be able to generate more personalized recommendations.

To address this problem, a system 100 of FIG. 1 introduces the capability to provide recommendations based on a recommendation model and a context-based rule, according to one embodiment. According to one embodiment, the system 100 receives a request for generating a recommendation, the request including a user identifier and/or an application identifier. Therefore, the recommendation may be specifically for the user and/or the application identified by the user identifier and/or the application identifier, respectively. The recommendation may relate to selection of applications executing at a device and/or items within the applications. For example, the recommendation may recommend a rock music playlist in a music application for the user. Next, the system 100 determines a recommendation model associated with the user identifier and/or the application identifier. The recommendation model may be a model built based on collected data, and may be specific to a user and/or an application based on the user identifier and/or the application. Then, the system 100 determines a context-based recommendation rule. The context may include time, location, schedule, speed, user profile, sound, etc. Therefore, context-based recommendation rule may be different depending on the context. For example, the context-based recommendation rule may result in using one recommendation model for someone standing but another recommendation model for someone riding on a bus. Further, the system 100 causes processing of the recommendation model and/or the context-based recommendation rule for generating the recommendation. Therefore, the context-based recommendation rule may generate a recommendation, and/or the recommendation model may generate a recommendation. In one example, the context-based recommendation rule may have a rule that designates the recommendation model to use for generating the recommendation. In scenarios where multiple recommendation models and/or context rules may apply to a particular type of recommendation or in a particular recommendation context, the system 100 can be configured with an order of precedence for deciding which models and/or rules to apply. In one embodiment, the order of precedence may be defined by a service provider, network operator, device manufacturer, user, and/or the like.

In a sample use case, a recommendation model may be built based on data collected at the user device. The data may contain information regarding the user interaction with applications and the usage of the applications. The applications may reside in both the device and a service. The recommendation model may also be specific to a user. Further, the context surrounding the user and the user device may be monitored by the device framework. Then, the context for the user may be used to generate a context-based rule to determine which recommendation model should be used. For example, if the user is travelling to Finland, the device would detect that the user is in Finland, and thus corresponding models and rules are retrieved for use while the user is in Finland. As one example, using the models and rules specific to Finland, the system may suggest recommendations for restaurants in Finland in the evening time.

As shown in FIG. 1, the system 100 comprises a user equipments (UEs) 101a-101n having connectivity to a recommendation platform 103 via a communication network 105. In this description, the UEs 101a-101n may be collective referred as the UE 101. The UE 101 also has connectivity to a service platform 107 and a content provider 117 via the communication network 105. The UE 101 may include a recommendation application 109, which communicates with the recommendation platform 103 to retrieve the information regarding recommendations. The recommendation platform 103 may receive data from the UE 101 that may be considered for recommendations. The recommendation platform 103 may exist within the UE 101, or within the service platform 107, or independently. The data provided to the recommendation platform 103 may include data from the sensor 109 connected to the UE 101. The sensor 109 may include a location sensor, a speed sensor, an audio sensor, brightness sensor, etc. The data storage 111 may be connected to the UE 101 to store the data captured via the sensor 109 as well as any other types of data, models, rules, etc. The recommendation platform 103 then may determine the recommendation rules and/or models based on various types of information. The recommendation platform 103 may also be connected to the platform storage medium 113, which can store various types of data including the rules, models, updates, etc. The recommendation platform 103 may also retrieve recommendation rules and/or models as well as updates for the rules and/or models from one or more services 115a-115m included in the service platform 107. The services 115a-115o can be collectively referred as the service 115. The rules and/or models and/or the updates may also exist in the one or more content providers 117a-117o, which may also be collectively referred as the content provider 117. Thus, the service platform 107 may include one or more services 115a-115m, the one or more content providers 117a-117o, or other content sources available or accessible over the communication network 105.

In one embodiment, the system 100 determines to retrieve the recommendation model from a general collaborative model based on the user identifier and/or the application identifier. By way of example, a pre-processing stage may take place to collect user data and to create a general collaborative model based on the collected data. For example, data about user interaction, user preferences, etc. may be collected from the UE 101, the service platform 107, and other devices, and then may be transferred to a server end (e.g. the service platform 107 and/or another service). The server end may use the collected data to generate the collaborative model. For example, the collected data may include information about the user and the applications. Then, the collected data may be referred with the user identifier and/or the applications. By way of example, there may be N users and M applications used by the users, and thus the general collaborative models may be generated for M applications. A collaborative filter applied to generate each collaborative model may be different, and may be taken from state-of the art. Each general collaborative model created at the server end may be N×T matrix, wherein T is the number of latent factors used to factorize the model. The number of row N may vary depending on the number of the users. In this matrix, each row belongs to each of the N users, wherein each user is identified by the user identifier. Further, each model may also have its own identifier indicating the application domain for which that recommendation model was constructed.

If the general collaborative model already exists in the UE 101, then the system 100 retrieves the recommendation model from the general collaborative model within the UE 101. On the other hand, if there are no general collaborative models for the user within the UE 101, then the system 100 retrieves the recommendation model from the general collaborative model at the server end. Also, if the system 100 determines that, although there is a general collaborative model for the user within the UE 101, there is an updated version of the general collaborative model for the user at the server end, the system 100 may utilize the updated version of the general collaborative model at the server end to retrieve the recommendation model. A request to retrieve the recommendation model or the updated version from the server end may include the user identifier and/or the application identifier.

Further, in one embodiment, the system 100 may cause processing of the recommendation model and/or other recommendation models associated with user identifier, to generate a user collaborative model, wherein the processing of the recommendation model comprises a processing of the user collaborative model. In this case, the user collaborative model may be organized by the application identifier and/or other application identifiers. For example, if there are N×T matrix models for M number of applications corresponding to N number of users for each application, 1×T matrix models corresponding to the user of the user identifier may be retrieved for M number of applications. Then, the system 100 may process these M number of recommendation models to form a user collaborative model, which is a M×T matrix model. Thus, the user collaborative model may be organized by multiple application identifiers. This M×T matrix model may be stored as a user collaborative model, and may be used to recommend applications or their usage. Each row in this M×T matrix user collaborative model may be associated with an identifier that identifies a source from which the row is taken from. The source may be the server end, as discussed previously. Therefore, this identifier may identify which application scenario that the corresponding row of the M×T matrix user collaborative model can be applied to. The system 100 may determine to cause storage of the recommendation model at a device associated with the user identifier. For example, the recommendation model retrieved from the general collaborative model may be stored at the data storage 111 of the UE 101. Also, the user collaborative model, which may be the M×T matrix model, may also be stored in the data storage 111. Then, these models are available for access by the UE 101, without the UE 101 having to retrieve them from the server end.

Further, in one embodiment, the system 100 determines context information associated with a user and/or a device associated with the user that are associated with the user identifier, wherein the determination of the context-based recommendation rule and/or the processing of the context-based recommendation rule is based on the context information. The server end may include the context-based recommendation rule. There may be context-based recommendation rules corresponding to the user identifier, the context and the type of the context. Therefore, the context-based recommendation rule may be organized by a context and/or a context type. Further, the context information may include sensor data, user schedule, calendar, etc. The context-based recommendation rules may also depend on a type of the device. Also, the system 100 may also cause an initiation of the processing of the context-based recommendation rule based on a change to the context information. In this example, if the sensor 109 that is a location sensor indicates that the UE 101's location has been changed from the United States to the United Kingdom, then the processing of the context-based recommendation rule is initiated to utilize the context-based recommendation rule for the United Kingdom.

Therefore, an advantage of this approach is that different recommendations may be made for various types of scenarios based on the context data. Because this approach enables the system 100 to use recommendation models, context-based rules, and/or a hybrid of models and rules to generate recommendations, the system 100 can more closely capture user preferences for recommendations. Therefore, means for recommendations based on a recommendation model and/or a context-based rule are anticipated.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the recommendation platform 103, the service platform 107 and the content provider 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

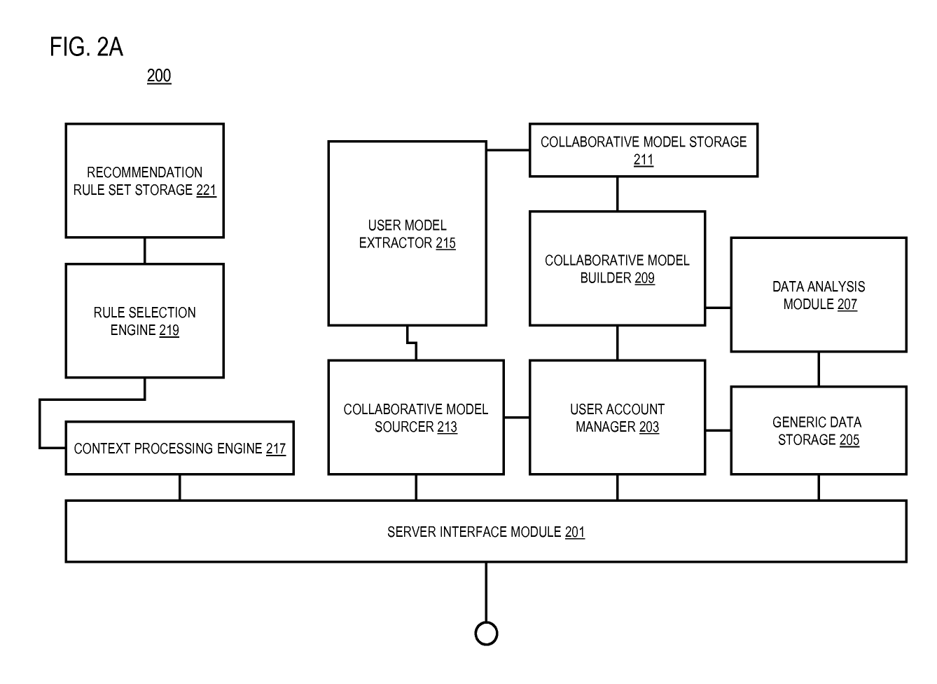

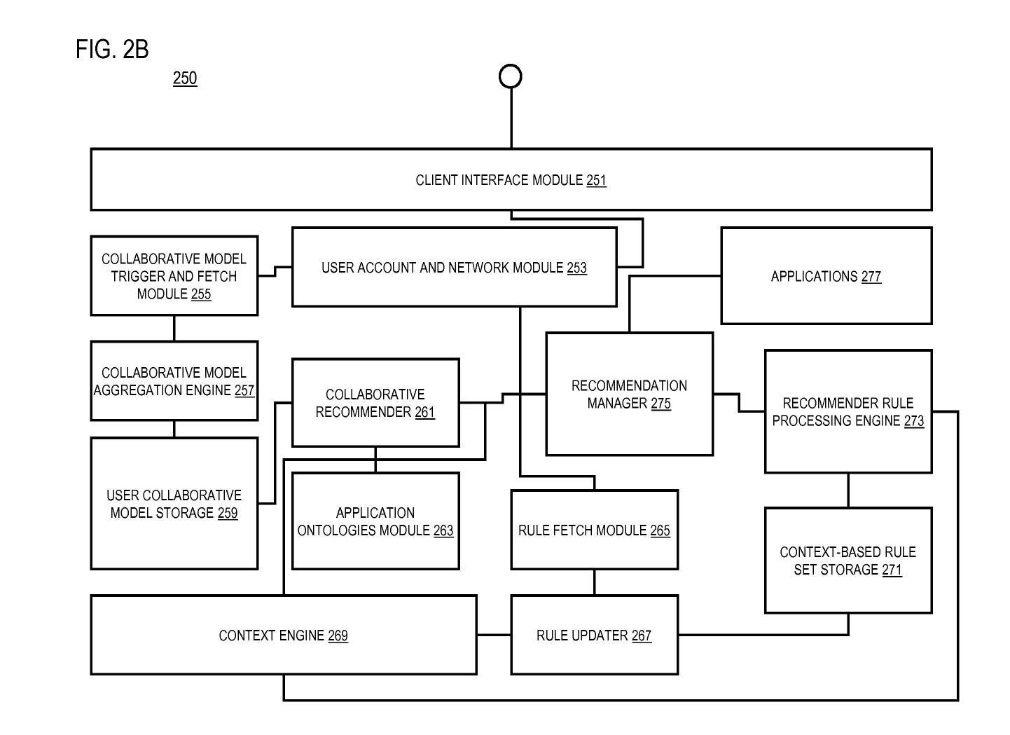

FIG. 2 is a diagram of the components of a server end and a client end, according to one embodiment. FIG. 2A shows a diagram of the components of the server end. The server end may comprise one or more services 115a-115m or any other services. FIG. 2B shows a diagram of the components of a client end. The client end may include the recommendation platform 103. By way of example, the recommendation platform 103 includes one or more components for providing recommendations based on a recommendation model and a context-based rule. It is contemplated that the functions of these components may be combined in one or more components or performed by other components of equivalent functionality.

In the embodiment shown in FIG. 2, the server end 200 in FIG. 2A includes a server interface module 201, a user account manager 203, a generic storage 205, a data analysis module 207, a collaborative model builder 209, a collaborative model storage 211, collaborative model sourcer 213 and a user model extractor 215. The server end 200 also includes a context processing engine 217, a rule selection engine 219 and a recommendation rule set storage 221. The server end 200 may exist at the service platform 107, in one embodiment. The server interface module 201 used to communicate with devices and/or services outside the server end 200. For example, the server interface module 201 may be used to send and receive signals, commands, requests, as well as data. The user account manager 203 may read a user identifier such that appropriate data can be processed based on the user identifier. The generic data storage 205 may be used to collect data received via the user interface module 201. For example, during a preprocessing stage, user data used to create a general collaborative model may be collected and stored at the generic data storage 205. The collected data may include data about user interaction, user preferences, etc. that can be collected from the UE 101, the service platform 107, and other devices. The data analysis module 207 may then retrieve this data from the generic data storage 205, and prepare the collected data to create a general collaborative model. The collaborative model builder 209 is used to create a general collaborative model based on the collected data received from the generic data storage 205. For example, if there are N users and M applications, then M number of general collaborative models may be created. Each general collaborative model may be created to include a N×T matrix, wherein T is the number of latent factors used to factorize the model. Thus, each general collaborative model has N rows, wherein each of the rows belongs to a user identified by the user identifier, and has an additional identifier such as an application identifier to indicate the application for which the general collaborative model was constructed. This general collaborative model may be stored at the collaborative model storage 211. The general collaborative model may be extracted by the user model extractor 215, when the collaborative model sourcer 213 receives a request for the general collaborative model.

In addition, the context processing engine 217 may be used to receive context data from a user device (e.g. UE 101), and/or a service via the server interface module 201, and relay the context data to the rule selection engine 219. Then, the rule selection engine 219 may select an appropriate rule set based on the context data such that the selected rule may be used for the scenarios within the context. The rule selection engine 219 may select the rule from the recommendation rule sets 221. The selected rule is sent to the client via the server interface module 201.

The server end 200 may also have a recommendation rule set storage 221 used to store the recommendation rule sets. The context information may include time, location, schedule, speed, user profile, sound, etc. Thus, there may be context-based recommendation rule for each context. The context processing engine 217 can read the context data received from the client end 250, and use the rule selection engine 219 to select an appropriate rule set for the received context. The context processing engine 217 then may be used to send the selected rule set to the client end 250 via the server interface module 201.

In FIG. 2A, the client 250 may include a client interface module 251, a user account and network module 253, a collaborative model trigger and fetch module 255, a collaborative model aggregation engine 257, a user collaborative model storage 259, a collaborative recommender 261, an application ontologies module 263. The client 250 may also include a rule fetch module 265, a rule updater 267, a context engine 269, a context-based rule set 271, a recommender rule processing engine 273, as well as a recommendation manager 275 and applications 277. The user account and network module 253 may receive a request for generating a recommendation, the request including a user identifier and/or an application identifier. By providing the user identifier and/or the application identifier in the request, the recommendation may be made specifically for the user and/or the application identified by the user identifier and/or the application identifier. Next, the recommendation manager 275 may be used to determine a recommendation model associated with the user identifier and/or the application identifier. The recommendation model may be retrieved from the general collaborative model based on the user identifier and/or the application identifier. As discussed previously, the general collaborative model may be created by the server end 200. Thus, the collaborative model trigger and fetch module 255 may be used to retrieve the recommendation model from the general collaborative model from the server end 200 via the user account and network module 253. For example, for each application, a 1×T matrix model may be retrieved from one of the rows in the N×T matrix model in the general collaborative model, wherein the retrieved 1×T matrix model corresponds to the user identifier in the request for generating a recommendation. If there are M number of applications for which the recommendation model is determined, then there will be M number of 1×T matrix models for the user identifier, wherein each of the M number of 1×T matrix models corresponds to at least one of M number of applications. The collaborative model aggregation engine 257 may process these 1×T matrix models associated with the user identifier to generate a user collaborative model. If there are M number of 1×T matrix models for the user identifier, these models may be aggregated to form a M×T matrix, which may be considered as a user collaborative model. Thus, this M×T matrix is the user collaborative model for the user identified by the user identifier, and each row of the M×T matrix is a recommendation model for its corresponding application, wherein there are M number of applications. The user collaborative model may be stored in the user collaborative model storage 259.

Then, the user collaborative model may be processed by the collaborative recommender 261 along with the application ontologies module 263 to generate recommendations. The application ontologies module 263 maps to the application identifiers identifying applications for the respective rows of the M×T matrix user collaborative model. Then, the collaborative recommender 261 can choose a row in the M×T matrix based on the input from the recommendation manager 275. The recommendation manager 275 may control the recommendation process, and may make recommendations for the applications 277 and/or items of the applications 277 based on the user collaborative model. Thus, the recommendation may relate to selection of applications executing at a device and/or items within the applications.

After determining the recommendation model (e.g. user collaborative model), the recommendation manager 275 determines a context-based recommendation rule. The context data associated with the user and/or the device of the user may be collected at the client end 250, and then may be sent to the server end 200, such that the context processing engine 217 can return a recommendation rule set to the client end 250, as discussed previously. Then, the recommender rule processing engine 273 processes the rule sets to generate the context-based recommendations, such that the context-based recommendations may be used by the recommendation manager 275 for generating recommendations. The context-based recommendation rule may also be stored in the context-based rule set storage 271. Then, the context-based recommendation rule may be retrieved from the context-based rule set storage 271 by the recommendation manager 275 when generating recommendations. The rules may be updated based on the changes in the context, by the rule updater 267. For example, changes to the context may be detected by the context engine 269, and this change may cause the rule updater 267 to initiate processing the context-based recommendation rule based on this change in the context information. Then, the rule fetch module 265 may cause transmission of the changes to the context information to the server end 200 such that the server end 200 may provide an updated recommendation rule set based on the changes to the context information.

With the recommendation models and the context-based models, the recommendation manager 275 may process the recommendation model and/or the context-based recommendation rule (via the rule processing engine) for generating the recommendation. For example, when the changes in the context are detected, the recommendation manager 275 may request the recommender rule processing engine 273 for output tokens, which denote application input data (data that will be passed to an application for example to initialize it) and/or model selection data. The application input data may be fed to an appropriate application, whereas the model selection data may be used to select an appropriate model from the user collaborative model. The model selected from the user collaborative model may be combined with input data for applications to generate recommendations.

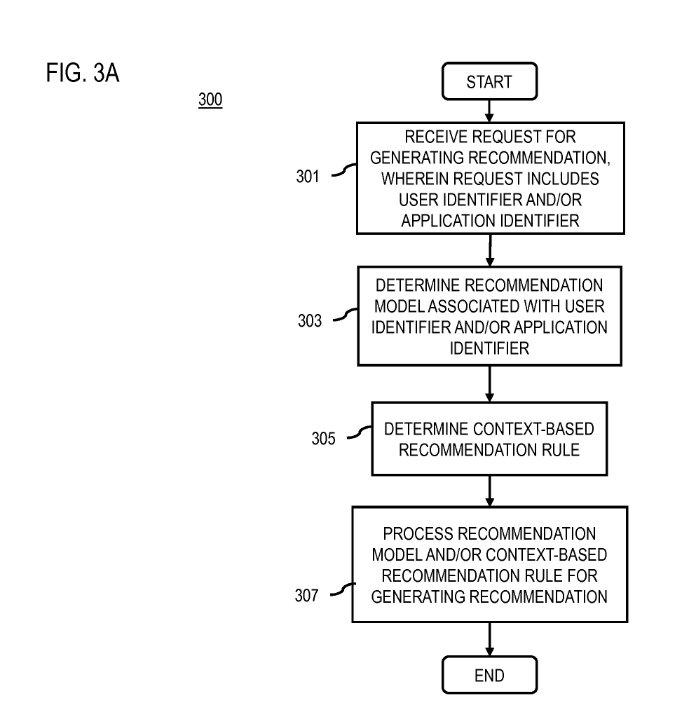

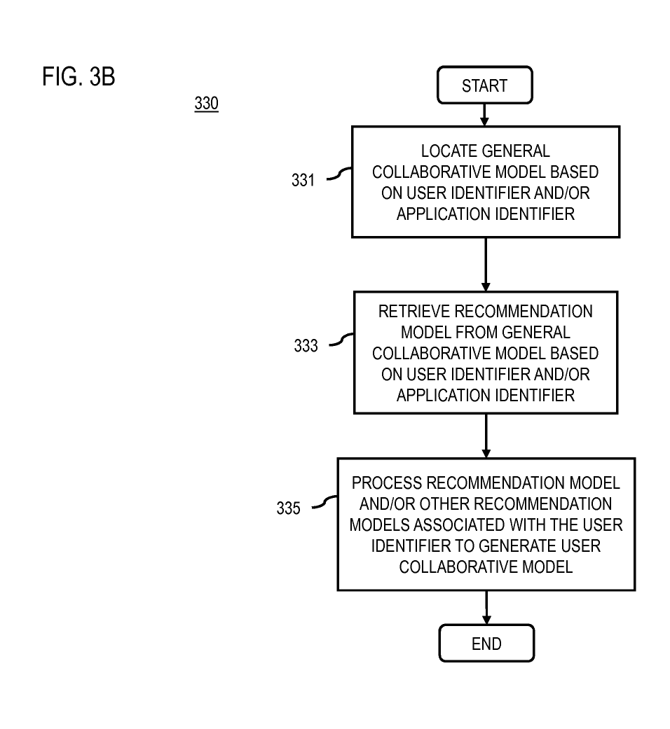

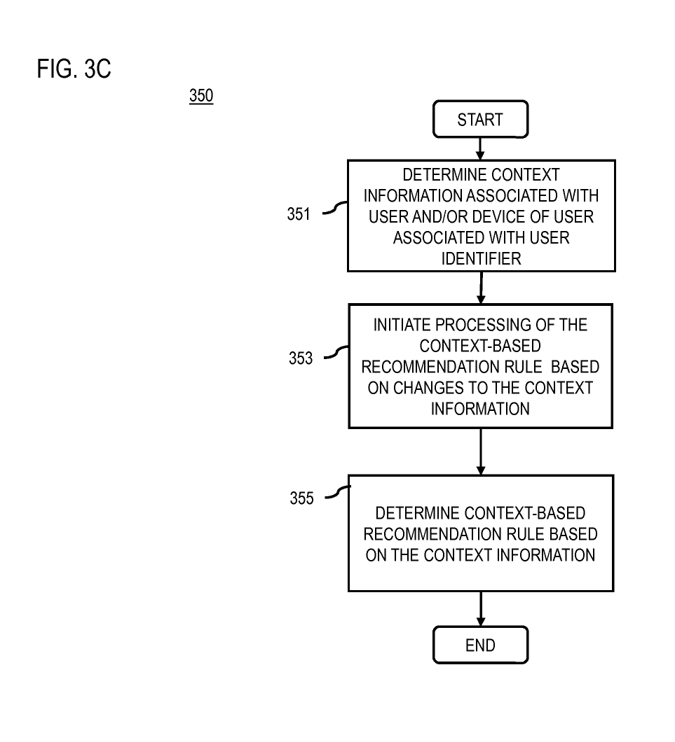

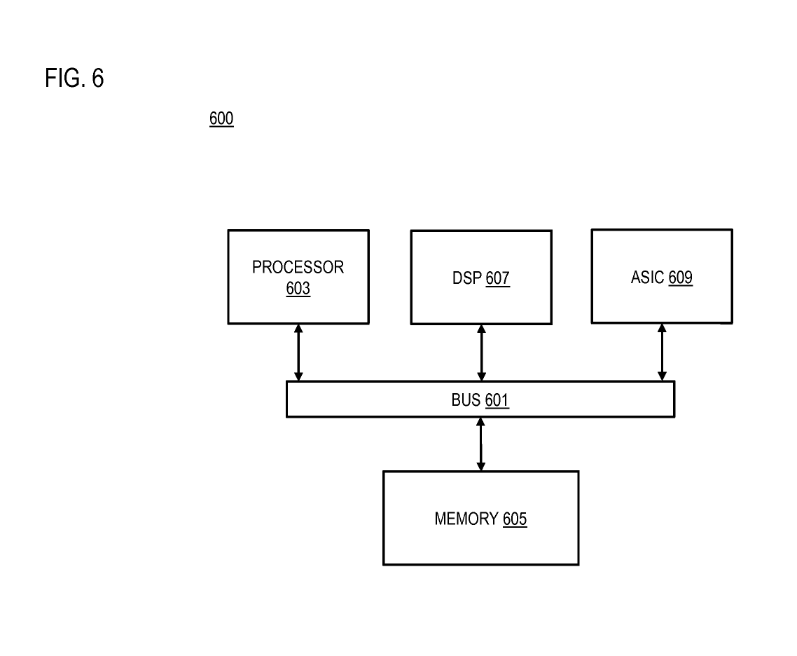

FIGS. 3A-3C are flowcharts of a process for providing recommendations based on a recommendation model and a context-based rule, according to one embodiment. In one embodiment, the recommendation platform 103 performs the process 300 and is implemented in, for instance, a chip set including a processor and a memory as shown in FIG. 6. FIG. 3A is a flowchart of the overall process for providing recommendations based on a recommendation model and a context-based rule, according to one embodiment. In step 301, the recommendation platform 103 receives a request for generating a recommendation, the request including a user identifier and/or an application identifier. Therefore, the recommendation may be specifically for the user and/or the application identified by the user identifier and/or the application identifier, respectively. The recommendation may relate to selection of applications executing at a device and/or items within the applications. For example, the recommendation may be a recommendation on a Christmas carol song if the recommendation platform 103 determines that it is a Christmas season. In step 303, the recommendation platform 103 determines a recommendation model associated with the user identifier and/or the application identifier. The recommendation model may be used to generate recommendations. For example, the recommendation model may include parameters that are basis for recommending certain applications and/or items of the applications, depending on the data on the user interaction with the application and/or the user's usage of the application. Then, in step 305, the recommendation platform 103 determines a context-based recommendation rule. The context may include time, location, speed, user profile, user calendar, sound, etc. The recommendation rule may be based on the contexts. For example, the context-based recommendation rule may cause selection of one recommendation model for a user in the United States but a different recommendation model for a user in Finland. Then, in step 307, the recommendation platform 103 causes processing of the recommendation model and/or the context-based recommendation rule for generating the recommendation. Thus, the recommendation may be generated based on both the recommendation model and the context-based recommendation rule.

FIG. 3B is a flowchart of a process of generating a user collaborative model, according to one embodiment. In step 331, the recommendation platform 103 locates general collaborative model based on the user identifier and/or the application identifier. The general collaborative model may be built at the server end during a preprocessing stage. For example, the server end (e.g. the service platform 107) may retrieve collect user data, wherein the user data may include data about user interaction, user preference, user usage of applications, items of applications, etc. The server end may use this data to create the general collaborative model. The data may include the user identifier and/or application identifier, to specify a corresponding user and/or application. In an example where there are N users and M applications, general collaborative models having a N×T matrix may be created, wherein T is the number of latent factors used to factorize the models. Each of the N users may be identified by the corresponding user identifier, which is in each row of the N×T matrix. Thus, for a general collaborative model for one application, each row having 1×T matrix represents one user's recommendation model for that one application. Further, because there are M applications, there may be M number of N×T matrix general collaborative models. The user identifier and the application identifiers indicated by the recommendation platform 103 may locate at least one 1×T matrix corresponding to the user of the user identifier, for the applications identified by the application identifiers.

Then, as shown in step 333, the recommendation platform 103 retrieves the recommendation model from the general collaborative model based on the user identifier and/or the application identifier. If there are M applications identified by the application identifiers, then the recommendation model retrieved from the general collaborative model may include M number of 1×T recommendation models for the user identified by the user identifier. Then, in step 335, the recommendation platform 103 processes the recommendation model and/or other recommendation models associated with the user identifier to generate the user collaborative model. In one example, these recommendation models may be aggregated to form a two-dimensional matrix of size M×T, because each of the recommendation models for M applications may be a 1×T matrix. This M×T matrix may be considered as the user collaborative model for the user identified by the user identifier. Thus, the user collaborative model may be organized by the M application identifiers corresponding to M applications. The recommendation models and/or the user collaborative model made up of the recommendation models may be stored within the UE 101.

FIG. 3C is a flowchart of a process of determining the context-based recommendation rule, according to one embodiment. In step 351, the recommendation platform 103 determines the context information associated with the user and/or the device associated with the user, wherein the user and/or the device associated with the user are associated with the user identifier. The context information may include the sensor data, calendar information, user profile, etc. The server end (e.g. the service platform 107) may include the context-based recommendation rules for various user identifiers. Therefore, the recommendation platform 103 may retrieve appropriate context-based recommendation rules based on the user identifier. In step 353, the recommendation platform 103 may initiate processing of the context-based recommendation rule based on changes to the context information. Thus, if there are changes to the context information in the UE 101, then this triggers processing of the context-based recommendation rule to reflect the changes. Then, in step 355, the context-based recommendation rule may be determined based on the context information.

This process is advantageous in that it provides a way to utilize both the recommendation model and the context-based recommendation rule to achieve a closely matched recommendation. The recommendation platform 103 is a means for achieving this advantage.

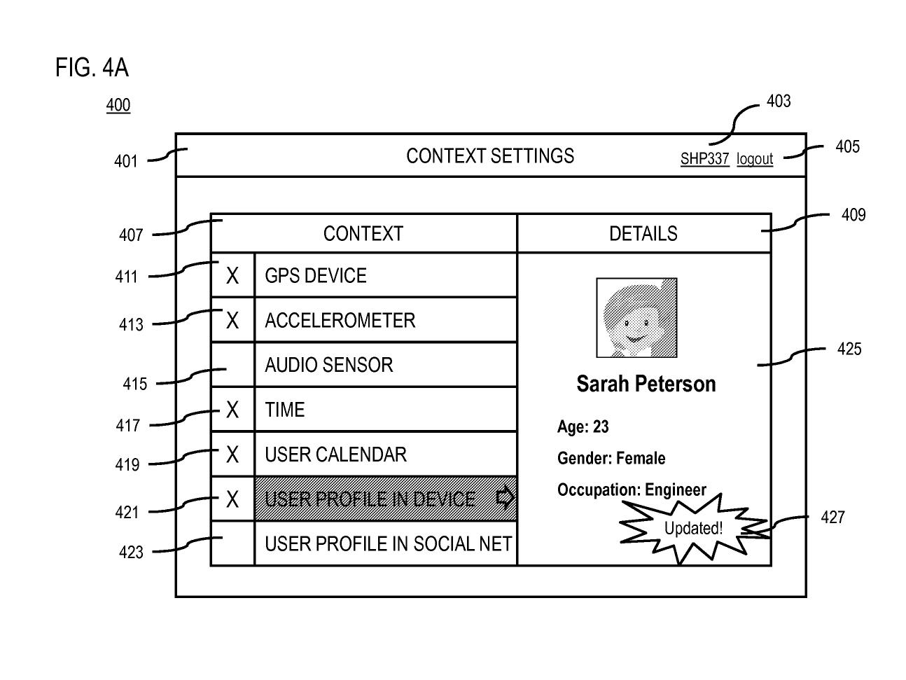

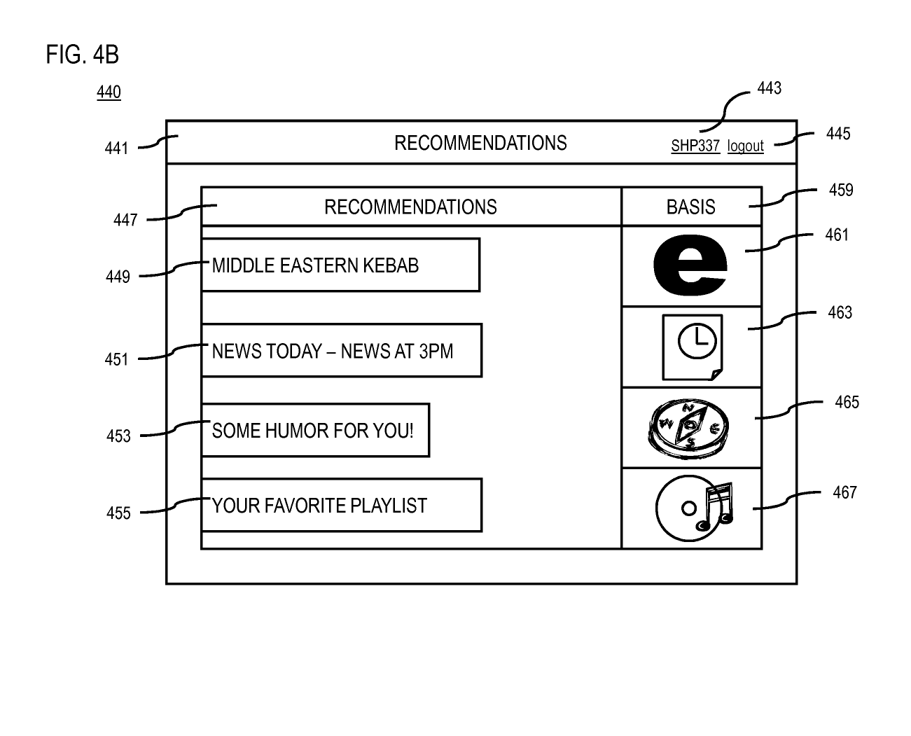

FIGS. 4A-4B are diagrams of user interfaces utilized in the processes of FIG. 3, according to one embodiment. FIG. 4A shows a user interface 400 for configuring settings for the context information used in the recommendation, according to one embodiment. The title section 401 shows that this user interface is for configuring contexts. The title section 401 also includes an indicator for a user “JSH337” 403, and a logout option 405 that can be selected to log out of the user's account. The context list section 407 shows a list of context data options that can be selected for consideration in generating the recommendation. The details section 409 shows details related to the context data. In this example, the context list section 407 lists a GPS device option 411, an accelerometer option 413, an audio sensor option 415, a time option 417, a user calendar option 419, a user profile in the device option 421 and a user profile in the social networking service option 423. Among these context data options, the GPS device option 411, the accelerometer option 413, the time option 417, the user calendar option 419 and the user profile in the device option 421 are selected for consideration in generating the recommendations, as indicated by the “X” mark. Further, the user profile in the device option 421 is highlight-selected to show the details about the user profile in the device. In the detail panel 425, the user profile information including a picture, a name, an age, gender and the occupation of the user is displayed. Further, the update sign 427 indicates that this context data is recently updated. Because the user profile in the device is recently updated, a new rule set corresponding with the updated user profile may be retrieved from the server end.

FIG. 4B shows a user interface 440 displaying recommendations, according to one embodiment. The title section 441 shows that this user interface is for providing recommendations. The title section 441 also includes an indicator for a user “JSH337” 443, and a logout option 445 that can be selected to log out of the user's account. The recommendations section 447 lists the recommendations generated based on the recommendation model and the context-based rules. In this example, the recommendations that have been generated include Middle Eastern Kebab restaurant 449, the News Today—News at 3 PM 451, Some Humor for You! program 453, and Your Favorite Songs 455 that can be played by a music application. The basis section 457 shows the main basis for the corresponding recommendations. The main basis for generating the Middle Eastern Kebab was the user's web browsing. For example, if the user frequently visits websites for kebabs, then this is taken into consideration in the recommendation. This reflects the user's interaction with the web browsing application, and is thus determined by the recommendation model. Further, the user's calendar 463 was a main basis for generating the News Today—News at 3 PM recommendation 451. This may be because the user has a block of free time between 3 PM and 4 PM, according to the user's calendar. The user's calendar may be considered a context data, and thus this recommendation may be mainly affected by the context. Further, the location map 465 is a main basis for the recommendation for a comedy program 453. For example, the user context on the location based on the GPS device may indicate that the user frequently visits comedy clubs. Further, the music application 467 may be basis for generating a recommendation for Your Favorite Playlist 455. In this example, the music application may 467 may collect data regarding the user's interaction with the music application to suggest the user's favorite playlist. Therefore, as shown in this example, both the recommendation model and the context-based rule may be used to generate the recommendations.

The processes described herein for providing recommendations based on a recommendation model and a context-based rule may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

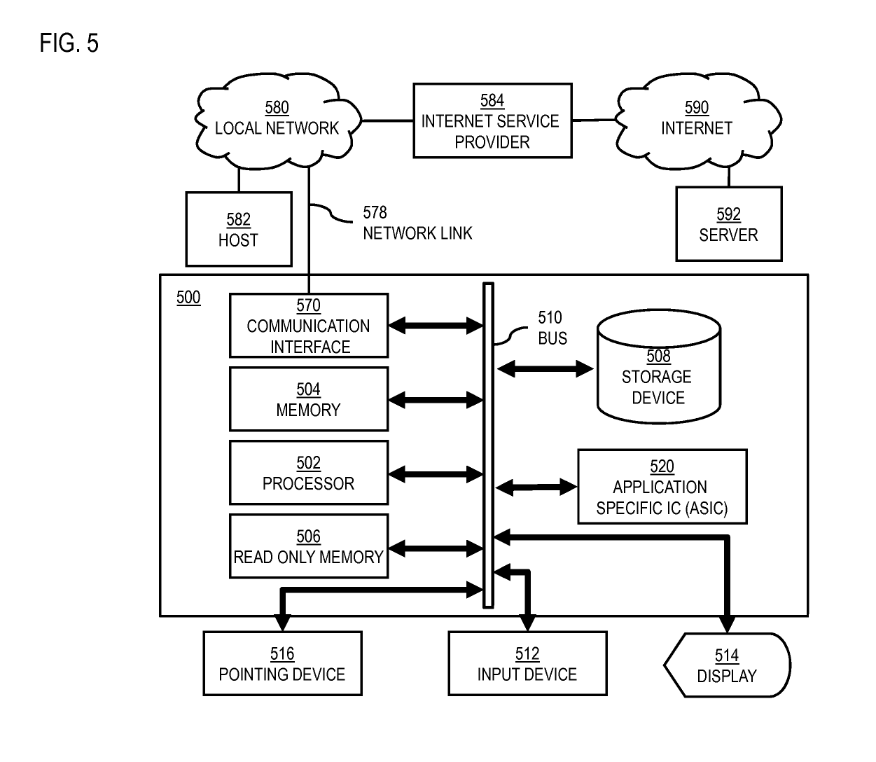

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to provide recommendations based on a recommendation model and a context-based rule as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of providing recommendations based on a recommendation model and a context-based rule.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to providing recommendations based on a recommendation model and a context-based rule. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for providing recommendations based on a recommendation model and a context-based rule. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing recommendations based on a recommendation model and a context-based rule, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for providing recommendations based on a recommendation model and a context-based rule.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to provide recommendations based on a recommendation model and a context-based rule as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of providing recommendations based on a recommendation model and a context-based rule.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide recommendations based on a recommendation model and a context-based rule. The memory 605 also stores the data associated with or generated by the execution of the inventive steps.

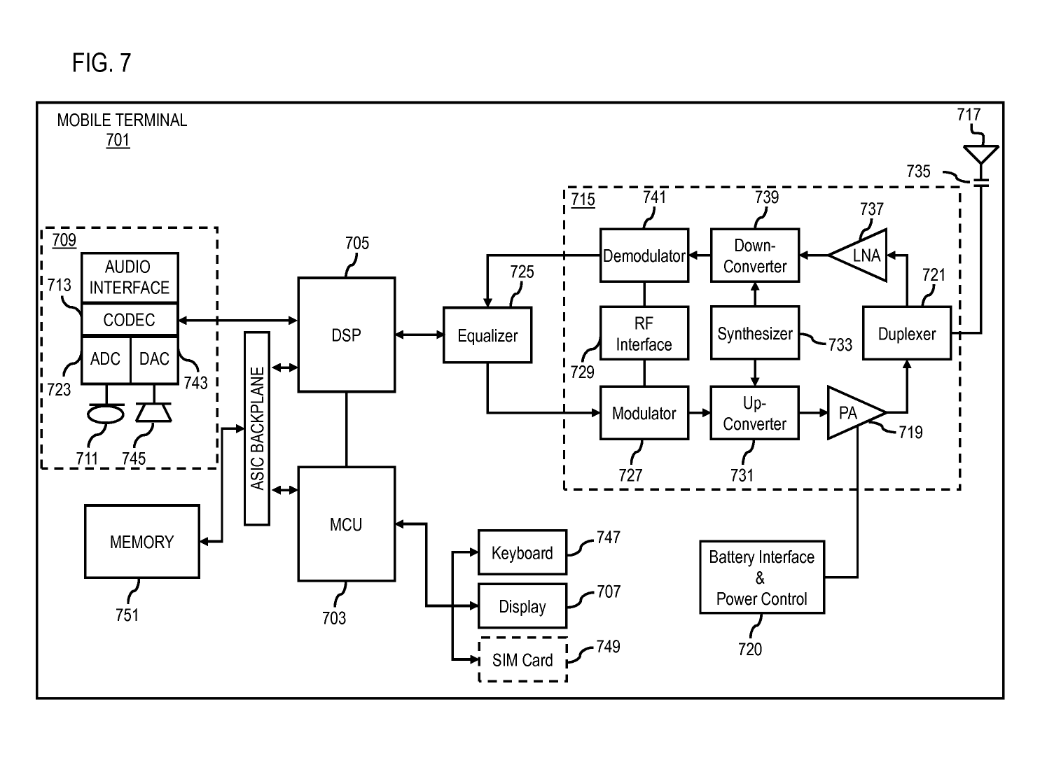

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of providing recommendations based on a recommendation model and a context-based rule. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of providing recommendations based on a recommendation model and a context-based rule. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to provide recommendations based on a recommendation model and a context-based rule. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request for generating at least one recommendation, the request including at least one user identifier, at least one application identifier, or a combination thereof;
at least one recommendation model associated with the at least one user identifier, the at least one application identifier, or a combination thereof
at least one context-based recommendation rule; and
a processing of the at least one recommendation model, the at least one context-based recommendation rule, or a combination thereof for generating the at least one recommendation.

2. A method of claim 1, wherein the (1) data and/or (2) information and/or (3) at least one signal are further based, at least in part, on the following:
at least one determination to retrieve the at least one recommendation model from a general collaborative model based, at least in part, on the at least one user identifier, the at least one application identifier, or a combination thereof.

3. A method of claim 2, wherein the (1) data and/or (2) information and/or (3) at least one signal are further based, at least in part, on the following:
a processing of the at least one recommendation model, one or more other recommendation models associated with the at least one user identifier, or a combination thereof to generate a user collaborative model,
wherein the processing of the at least one recommendation model comprises at least in part a processing of the user collaborative model.

4. A method of claim 3, wherein the user collaborative model is organized by the at least one application identifier, one or more other application identifiers, or a combination thereof.

5. A method of claim 1, wherein the (1) data and/or (2) information and/or (3) at least one signal are further based, at least in part, on the following:
context information associated with a user, a device associated with the user, or a combination thereof associated with the at least one user identifier,
wherein the determination of the at least one context-based recommendation rule, the processing of the at least one context-based recommendation rule, or a combination thereof is based, at least in part, on the context information.

6. A method of claim 5, wherein the (1) data and/or (2) information and/or (3) at least one signal are further based, at least in part, on the following:
a processing of the at least one context-based recommendation rule based, at least in part, on at least one change to the context information.

7. A method of claim 1, wherein the at least one context-based recommendation rule is organized by at least one context, at least one context type, or a combination thereof.

8. A method of claim 1, wherein the at least one recommendation relates to selection of one or more applications executing at a device, one or more items within the one or more applications, or a combination thereof.

9. A method of claim 1, wherein the (1) data and/or (2) information and/or (3) at least one signal are further based, at least in part, on the following:
at least one storage of the at least one recommendation model, the at least one context-based recommendation rule, or a combination thereof at least one device associated with the at least one user identifier.

10. A method of claim 1, wherein the (1) data and/or (2) information and/or (3) at least one signal are further based, at least in part, on the following:
at least one determination that at least one device associated with the at least one user identifier has network connectivity; and
at least one transmission of the at least one recommendation model, the at least one context-based recommendation rule, or a combination thereof to the at least one device.

11. An apparatus comprising:
at least one processor; and
at least one memory including computer program code for one or more programs,
the at least one memory and the computer program code configured to, with the at least one processor, cause the apparatus to perform at least the following,
receive a request for generating at least one recommendation, the request including at least one user identifier, at least one application identifier, or a combination thereof;
determine at least one recommendation model associated with the at least one user identifier, the at least one application identifier, or a combination thereof
determine at least one context-based recommendation rule; and
process and/or facilitate a processing of the at least one recommendation model, the at least one context-based recommendation rule, or a combination thereof for generating the at least one recommendation.

12. An apparatus of claim 11, wherein the apparatus is further caused to:
determine to retrieve the at least one recommendation model from a general collaborative model based, at least in part, on the at least one user identifier, the at least one application identifier, or a combination thereof.

13. An apparatus of claim 12, wherein the apparatus is further caused to:
process and/or facilitate a processing of the at least one recommendation model, one or more other recommendation models associated with the at least one user identifier, or a combination thereof to generate a user collaborative model,
wherein the processing of the at least one recommendation model comprises at least in part a processing of the user collaborative model.

14. An apparatus of claim 13, wherein the user collaborative model is organized by the at least one application identifier, one or more other application identifiers, or a combination thereof.

15. An apparatus of claim 11, wherein the apparatus is further caused to:
process and/or facilitate a processing of context information associated with a user, a device associated with the user, or a combination thereof associated with the at least one user identifier,
wherein the determination of the at least one context-based recommendation rule, the processing of the at least one context-based recommendation rule, or a combination thereof is based, at least in part, on the context information.

16. An apparatus of claim 11, wherein the apparatus is further caused to:
process and/or facilitate a processing of the at least one context-based recommendation rule based, at least in part, on at least one change to the context information.

17. An apparatus of claim 11, wherein the apparatus is further caused to:
determine to cause, at least in part, storage of the at least one recommendation model, the at least one context-based recommendation rule, or a combination thereof at least one device associated with the at least one user identifier.

18. An apparatus of claim 11, wherein the apparatus is further caused to:
determine that at least one device associated with the at least one user identifier has network connectivity; and
cause, at least in part, transmission of the at least one recommendation model, the at least one context-based recommendation rule, or a combination thereof to the at least one device.

19. A computer-readable storage medium carrying one or more sequences of one or more instructions which, when executed by one or more processors, cause an apparatus to at least perform the following steps:
receiving a request for generating at least one recommendation, the request including at least one user identifier, at least one application identifier, or a combination thereof;
determining at least one recommendation model associated with the at least one user identifier, the at least one application identifier, or a combination thereof determining at least one context-based recommendation rule; and
processing and/or facilitating a processing of the at least one recommendation model, the at least one context-based recommendation rule, or a combination thereof for generating the at least one recommendation.

20. A computer-readable storage medium of claim 19, wherein the apparatus is caused to further perform:
determining to retrieve the at least one recommendation model from a general collaborative model based, at least in part, on the at least one user identifier, the at least one application identifier, or a combination thereof.

21.-49. (canceled)
